(19) United States
(12) Patent Application Publication
(10) Pub. No.: US 2024/0135249 A1
(43) Pub. Date: Apr. 25, 2024

(54) LEARNING DEVICE, LEARNING METHOD, AND PROGRAM

(71) Applicant: NIPPON TELEGRAPH AND TELEPHONE CORPORATION, Tokyo (JP)

(72) Inventors: Shota ORIHASHI, Tokyo (JP); Masato SAWADA, Tokyo (JP)

(73) Assignee: NIPPON TELEGRAPH AND TELEPHONE CORPORATION, Tokyo (JP)

(21) Appl. No.: 18/279,595

(22) PCT Filed: Mar. 1, 2021
(86) PCT No.: PCT/JP2021/007627

§ 371 Date: Aug. 29, 2023

(51) Int. Cl. G06N 20/00

(52) U.S. Cl. CPC G06N 20/00

(57) ABSTRACT

A learning device (10) according to the present disclosure includes a data set division unit (11) as a training data processing unit and a divided data set learning unit (12) as a model learning unit. The data set division unit (11) divides a new training data set into a plurality of divided data sets on the basis of attribute information. After performing model learning processing using an existing model as a learning target model, the divided data set learning unit (12) creates a new model by repeating the model learning processing until all the divided data sets are learned using a learned model created by the model learning processing as a new learning target model.

### TECHNICAL FIELD

The present disclosure relates to a learning device, a learning method, and a program.

### BACKGROUND ART

In recent years, for the purpose of improving the service quality in a contact center, there has been proposed a system that performs voice recognition on call content in real time and automatically presents appropriate information to an operator who is receiving a call by making full use of natural language processing technology.

For example, Non Patent Literature 1 discloses a technique of presenting questions assumed in advance and answers to the questions (FAQ) to an operator in conversation between the operator and a customer. In this technology, conversation between an operator and a customer is subjected to voice recognition, and is converted into a semantic utterance text by “utterance end determination” for determining whether the speaker has finished speaking. Next, “service scene estimation” for estimating in which service scene in conversation the utterance corresponding to the utterance text is, such as greetings by the operator, confirmation of a requirement of the customer, response to the requirement, or closing of the conversation, is performed. The conversation is structured by the “service scene estimation”. From a result of the “service scene estimation”, “FAQ retrieval utterance determination” for extracting utterance including a requirement of the customer or utterance in which the operator confirms a requirement of the customer is performed. Retrieval using a retrieval query based on the utterance extracted by the “FAQ retrieval utterance determination” is performed on a database of the FAQ prepared in advance, and a retrieval result is presented to the operator.

For the above-described “utterance end determination”, “service scene estimation”, and “FAQ retrieval utterance determination”, a model constructed by learning training data in which labels for classifying utterance are assigned to utterance texts using a deep neural network or the like is used. Therefore, the “utterance end determination”, the “service scene estimation”, and the “FAQ retrieval utterance determination” can be regarded as a series of labeling problems for labeling a series of elements (utterance in conversation). Non Patent Literature 2 describes a technique of estimating a service scene by learning a large amount of training data in which labels corresponding to service scenes including a series of utterance is assigned to the utterance using a deep neural network including long and short term memory.

### CITATION LIST

### Non Patent Literature

Non Patent Literature 1: Takaaki Hasegawa, Yuichiro Sekiguchi, Setsuo Yamada, Masafumi Tamoto, “Automatic Recognition Support System That Supports Operator Service,” NTT Technical Journal, vol. 31, no. 7, pp. 16-19, July 2019.
Non Patent Literature 2: R. Masumura, S. Yamada, T. Tanaka, A. Ando, H. Kamiyama, and Y. Aono, “Online Call Scene Segmentation of Contact Center Dialogues based on Role Aware Hierarchical LSTM-RNNs,” Asia-Pacific Signal and Information Processing Association Annual Summit and Conference (APSIPA ASC), November 2018.

### SUMMARY OF INVENTION

### Technical Problem

In techniques described in Non Patent Literature 1 and 2 described above, a large amount of training data is required in order to set the estimation accuracy to a level for practical use. For example, according to Non Patent Literature 1, high estimation accuracy can be obtained by training data being created from conversation logs of a call center of about 1000 calls and a model being learned.

In a case of improving the estimation accuracy of an existing model or coping with a new issue, learning the model again using training data used for learning the existing model (existing training data) and training data that is new (new training data) is desirable. However, if all the existing training data and the new training data are used, it takes time to learn the model and evaluate the accuracy. In particular, since call data in a contact center is relevant to personal information, keeping the existing training data causes an increase in data storage cost. Furthermore, in actual operation in business, the existing training data may be discarded and unavailable due to restriction of a storage period of personal information.

Therefore, as illustrated in FIG. 13, a method of performing fine tuning of creating a new model using an existing model by additional learning of new training data including new training data for learning and new training data for evaluation for an existing model created by learning of an existing training data set including existing training data for learning and existing training data for evaluation can be considered. However, in this method, there is an issue that the tendency of the learned existing training data is forgotten by learning of the new training data set, and the estimation accuracy for the existing training data set is lowered. This issue is particularly noticeable in a case where additional learning is performed without an attribute of data (target industry, service, purpose, and the like) included in the training data set being considered.

Therefore, there is a demand for a technique that enables suppressing deterioration of estimation accuracy in a case where new training data is additionally learned for an existing model.

An object of the present disclosure made in view of the above issues is to provide a learning device, a learning method, and a program capable of suppressing deterioration of estimation accuracy in a case where new training data is additionally learned for an existing model.

### Solution to Problem

In order to solve the above issues, a learning device according to the present disclosure is a learning device that adds a new training data set including a plurality of pieces of training data to an existing model learned using an existing training data set and learns a new model, the learning device including a training data processing unit that processes the new training data set on the basis of attribute information of the existing training data set or the new training data set, and a model learning unit that creates the new model by additionally learning a new training data set processed by the training data processing unit for the existing model.

Furthermore, in order to solve the above issues, a learning method according to the present disclosure is a learning method for adding a new training data set including a plurality of pieces of training data to an existing model learned using an existing training data set and learning a new model, the learning method including a step of processing the new training data set on the basis of attribute information of the existing training data set or the new training data set, and a step of creating the new model by additionally learning the processed new training data set for the existing model.

Furthermore, in order to solve the above issues, a program according to the present disclosure causes a computer to function as the learning device described above.

### Advantageous Effects of Invention

According to a learning device, a learning method, and a program according to the present disclosure, deterioration of estimation accuracy can be suppressed in a case where new training data is additionally learned for an existing model.

### BRIEF DESCRIPTION OF DRAWINGS

FIG. 1 is a block diagram illustrating a schematic configuration of a computer that functions as a learning device according to a first embodiment of the present disclosure.

FIG. 2 is a diagram illustrating a functional configuration example of the learning device according to the first embodiment of the present disclosure.

FIG. 3 is a diagram schematically illustrating learning of a new model by the learning device illustrated in FIG. 2.

FIG. 4 is a diagram illustrating an example of operation of the learning device illustrated in FIG. 2.

FIG. 5 is a diagram illustrating a functional configuration example of a learning device according to a second embodiment of the present disclosure.

FIG. 6 is a diagram schematically illustrating learning of a new model by the learning device illustrated in FIG. 5.

FIG. 7 is a diagram illustrating an example of operation of the learning device illustrated in FIG. 5.

FIG. 8 is a diagram illustrating a functional configuration example of a learning device according to a third embodiment of the present disclosure.

FIG. 9 is a diagram schematically illustrating learning of a new model by the learning device illustrated in FIG. 8.

FIG. 10 is a diagram illustrating an example of operation of the learning device illustrated in FIG. 8.

FIG. 11 is a diagram illustrating a functional configuration example of the learning device according to the third embodiment of the present disclosure.

FIG. 12 is a diagram illustrating evaluation results of accuracy of models created by first to fourth methods.

FIG. 13 is a diagram schematically illustrating learning of a new model by a conventional learning device.

### DESCRIPTION OF EMBODIMENTS

Hereinafter, embodiments of the present disclosure will be described with reference to the drawings.

### First Embodiment

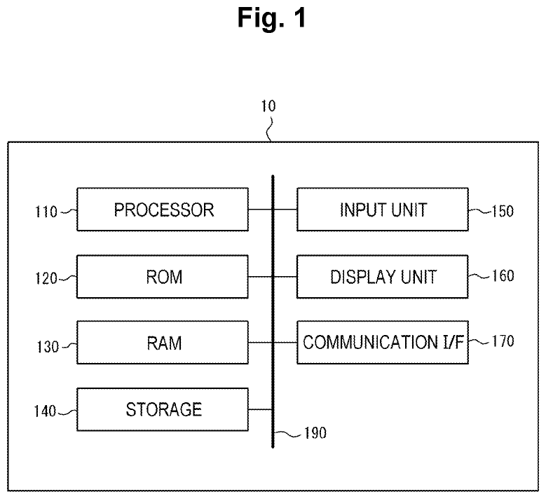

FIG. 1 is a block diagram illustrating a hardware configuration in a case where a learning device 10 according to a first embodiment of the present disclosure is a computer capable of executing a program command. Here, the computer may be a general-purpose computer, a dedicated computer, a workstation, a personal computer (PC), an electronic note pad, or the like. The program command may be a program code, code segment, or the like for executing a necessary task.

As illustrated in FIG. 1, the learning device 10 includes a processor 110, a read only memory (ROM) 120, a random access memory (RAM) 130, a storage 140, an input unit 150, a display unit 160, and a communication interface (I/F) 170. The components are communicably connected to each other via a bus 190. Specifically, the processor 110 is a central processing unit (CPU), a micro processing unit (MPU), a graphics processing unit (GPU), a digital signal processor (DSP), a system on a chip (SoC), or the like and may be configured by the same or different types of a plurality of processors.

The processor 110 executes control of the components and various types of arithmetic processing. That is, the processor 110 reads a program from the ROM 120 or the storage 140 and executes the program using the RAM 130 as a working area. The processor 110 executes control of the above components and various types of arithmetic processing according to a program stored in the ROM 120 or the storage 140. In the present embodiment, a program according to the present disclosure is stored in the ROM 120 or the storage 140.

The program may be provided in a form in which the program is stored in a non-transitory storage medium, such as a compact disk read only memory (CD-ROM), a digital versatile disk read only memory (DVD-ROM), and a universal serial bus (USB) memory. The program may be downloaded from an external device via a network.

The ROM 120 stores various programs and various types of data. The RAM 130 as a work area temporarily stores programs or data. The storage 140 includes a hard disk drive (HDD) or a solid state drive (SSD) and stores various programs including an operating system and various types of data.

The input unit 150 includes a pointing device such as a mouse and a keyboard and is used to perform various inputs.

The display unit 160 is, for example, a liquid crystal display, and displays various types of information. A touch panel system may be adopted so that the display unit 160 can function as the input unit 150.

The communication interface 170 is an interface for communicating with another device such as an external device (not illustrated), and for example, a standard such as Ethernet (registered trademark), FDDI, and Wi-Fi (registered trademark) is used.

Next, a functional configuration of the learning device 10 according to the present embodiment will be described.

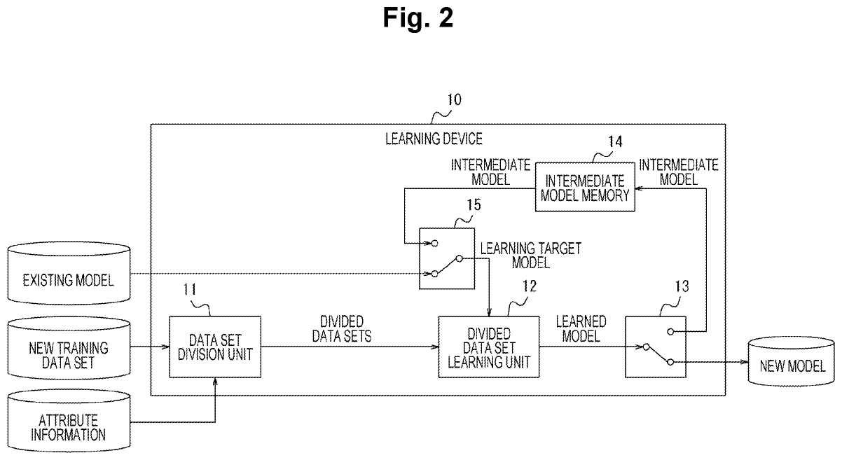

FIG. 2 is a diagram illustrating the functional configuration example of the learning device 10 according to the present embodiment. The learning device 10 according to the present embodiment creates a new model by additionally learning a new training data set for an existing model created by learning of an existing training data set. Hereinafter, description will be given using an example in which training data is data in which labels are assigned to utterance texts corresponding to utterance (hereinafter, the utterance texts corresponding to the utterance may be simply referred to as “utterance texts”) obtained by performing voice recognition on the utterance in conversation by a plurality of speakers (operator and customer) at a contact center.

As labels assigned to utterance texts, there are utterance end labels each indicating whether the utterance is an utterance end. Furthermore, as labels assigned to utterance texts, there are scene labels each indicating in which scene in conversation the utterance is, such as greetings by an operator, confirmation of a requirement of a customer, and response to the requirement. Furthermore, as labels assigned to utterance texts, there are requirement labels each indicating that the utterance is utterance indicating a requirement of a customer or requirement confirmation labels each indicating that the utterance is utterance in which an operator confirms a requirement of the customer.

Note that the present disclosure is not limited to the above-described example, and can be applied to learning using a plurality of any elements and training data in which labels are assigned to each of the elements. Furthermore, an utterance text may be not only utterance in a call converted into a text, but also utterance in text conversation such as chat. Furthermore, a speaker in conversation is not limited to a human, and may be a robot, a virtual agent, or the like.

As illustrated in FIG. 2, the learning device 10 according to the present embodiment includes a data set division unit 11 as a training data processing unit, a divided data set learning unit 12 as a model learning unit, switching units 13 and 15, and an intermediate model memory 14. The data set division unit 11, the divided data set learning unit 12, and the switching units 13 and 15 may be configured by dedicated hardware such as an application specific integrated circuit (ASIC) or a field-programmable gate array (FPGA), may be configured by one or more processors as described above, or may be configured to include both dedicated hardware and a processor. The intermediate model memory 14 includes, for example, a RAM 130 or a storage 140.

A new training data set and attribute information are input to the data set division unit 11. The new training data set is a set of pieces of training data in which utterance texts obtained from each of a plurality of calls and labels of the utterance texts are associated with each other, and is a set of pieces of training data newly used for model learning (new training data). That is, the new training data set includes a plurality of pieces of training data. The attribute information is information regarding an attribute that partitions data included in an existing training data set and the new training data set. The attribute information is, for example, information that associates classification such as an industry to be handled in the contact center, service to be inquired, or a purpose of the inquiry with call data. Note that, the existing training data set is a set of pieces of training data in which utterance texts obtained from each of a plurality of calls and labels of the utterance texts are associated with each other, and is a set of pieces of training data used for learning of an existing model (existing training data).

The data set division unit 11 as a training data processing unit processes the new training data set on the basis of the attribute information of the existing training data set or the new training data set. Specifically, the data set division unit 11 divides the new training data set into a plurality of data sets (hereinafter, referred to as “divided data sets”) on the basis of the attribute information. The data set division unit 11 outputs the plurality of divided data sets obtained by dividing the new training data set to the divided data set learning unit 12.

The divided data set learning unit 12 receives the plurality of divided data sets divided by the data set division unit 11 and a learning target model output from the switching unit 15 to be described below. The divided data set learning unit 12 as a model learning unit creates a new model by additionally learning new training data sets processed (divided) by the data set division unit 11 (divided data sets) for the learning target model. Specifically, the divided data set learning unit 12 performs model learning processing of creating a learned model by additionally learning one divided data set among the plurality of divided data sets for the input learning target model, and outputs the model after the learning to the switching unit 13 as a learned model. Here, as will be described below, the existing model is first output as a learning target model from the switching unit 15, and thereafter an intermediate model to be detailed (learned model) is output as a learning target model. After performing the model learning processing using the existing model output from the switching unit 15 as a learning target model, the divided data set learning unit 12 sets a learned model created by the model learning processing as a new learning target model and repeats the model learning processing until all the divided data sets are learned.

The switching unit 13 outputs the learned model created by the divided data set learning unit 12 to the outside of the learning device 10 or the intermediate model memory 14. Specifically, the switching unit 13 outputs the learned model created by the divided data set learning unit 12 to the intermediate model memory 14 as an intermediate model until learning of all the divided data sets is completed. The switching unit 13 outputs the learned model created by the divided data set learning unit 12 as a new model in a case where learning of all the divided data sets is completed.

The intermediate model memory 14 stores the intermediate model output from the switching unit 13, and outputs the stored intermediate model to the switching unit 15 in response to the model learning processing by the divided data set learning unit 12.

The existing model and the intermediate model output from the intermediate model memory 14 are input to the switching unit 15. The switching unit 15 first outputs the existing model as a learning target model to the divided data set learning unit 12, and thereafter outputs the intermediate model output from the intermediate model memory 14 as a learning target model to the divided data set learning unit 12.

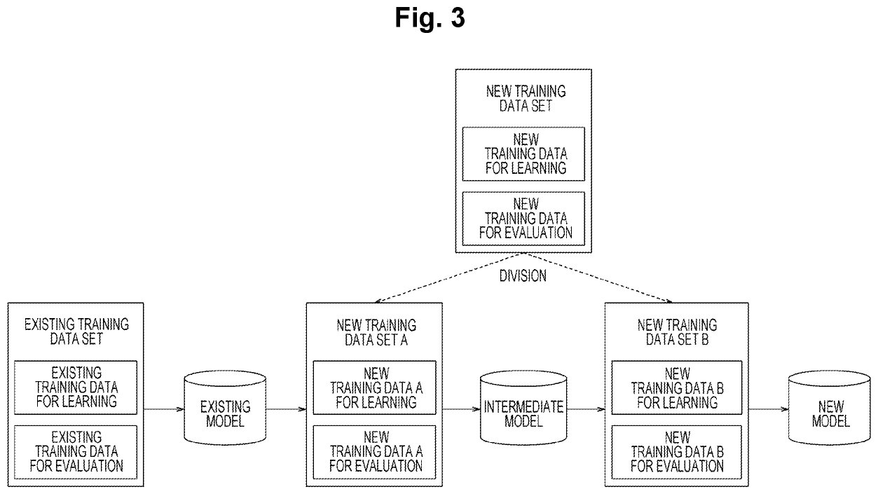

FIG. 3 is a diagram schematically illustrating learning of a new model by the learning device 10 according to the present embodiment.

As illustrated in FIG. 3, the existing model is created by learning the existing training data set including existing training data for learning and existing training data for evaluation. In a case where a new model is created by a new training data set including new training data for learning and new training data for evaluation being additionally learned for the existing model created by learning of the existing training data set, the data set division unit 11 processes (divides) the new training data set on the basis of the attribute information. In the example illustrated in FIG. 3, the data set division unit 11 divides the new training data set into two data sets (new training data set A and new training data set B).

In FIG. 3, an example in which the data set division unit 11 divides the new training data set into two is illustrated, but the present disclosure is not limited thereto. The data set division unit 11 may divide the new training data set into any number of divided data sets on the basis of the attribute information of the new training data set. The data set division unit 11 may divide the new training data such that only a data set having one attribute is included in one divided data set. The data set division unit 11 may divide the new training data set such that the number of pieces of data included in a divided data set is 1/n (n is any integer) of the number of pieces of existing training data included in the existing training data set or the number of pieces of new training data included in the new training data set. The data set division unit 11 may perform division such that a data set having a plurality of attributes is included in one divided data set. However, in this case, the data set division unit 11 divides the new training data set such that a data set having one attribute is not included in a plurality of divided data sets. Furthermore, the data set division unit 11 may divide the new training data set according to a plurality of patterns having different division numbers. The division numbers of the new training data set may be designated by a user, or may be set by the data set division unit 11 on the basis of the attribute information.

First, the existing model is input to the divided data set learning unit 12 as a learning target model. The divided data set learning unit 12 creates a learned model by additionally learning one divided data set (new training data set A in the example illustrated in FIG. 3) among the plurality of divided data sets for the existing model input as a learning target model. Since learning of all the divided data sets is not completed, the learned model created by the divided data set learning unit 12 is stored in the intermediate model memory 14 as an intermediate model.

Next, the intermediate model stored in the intermediate model memory 14 is input to the divided data set learning unit 12 as a learning target model. The divided data set learning unit 12 creates a learned model by additionally learning an unlearned divided data set (new training data set B in the example illustrated in FIG. 3) for the intermediate model input as a learning target model. Since learning of all the divided data sets is completed, the learned model created by the divided data set learning unit 12 is output as a new model.

As described above, the new training data set may be divided into three or more divided data sets. In a case where the new training data set is divided into N divided data sets, the divided data set learning unit 12 creates a learned model (intermediate model) by additionally learning a first learned data set for the existing model. The divided data set learning unit 12 creates a learned model by additionally learning a second learned data set for the intermediate model. The divided data set learning unit 12 repeats such model learning processing until all the (N) divided data sets are learned. For example, the divided data set learning unit 12 additionally learns all the divided data sets and outputs a finally created learned model as a new model. That is, the divided data set learning unit 12 creates a learned model by additionally learning one divided data set among the plurality of divided data sets for the existing model, and then repeats the model learning processing until all the divided data sets are learned using intermediate models as learning target models.

The divided data set learning unit 12 may output, as a new model, a learned model having the best index such as precision, recall, or an F-score among learned models (intermediate models) created by additional learning of each of the N pieces of divided training data. The divided data set learning unit 12 may freely change the order of learning the divided data sets, the division number of the training data set by the data set division unit 11, and the like, and output a learned model having the best desired index as a new model.

By the new training data set being divided into the plurality of divided data sets and the divided data sets being additionally learned little by little in a plurality of times, forgetting of the tendency of the learned existing training data set can be suppressed as compared with a case where a large amount of new training data is learned at a time. Therefore, deterioration of estimation accuracy for the existing training data set can be suppressed. Furthermore, by the new training data set being processed (divided) according to the attribute information, a parameter of a model for each attribute can be gently updated in multiple stages, and thus deterioration of estimation accuracy for the existing training data set can be suppressed.

Next, operation of the learning device 10 according to the present embodiment will be described.

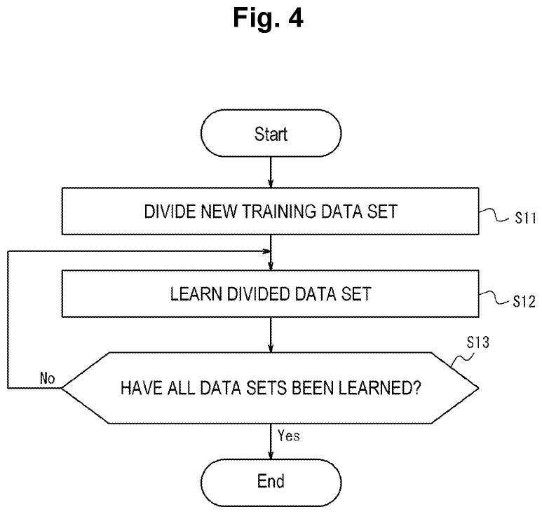

FIG. 4 is a flowchart illustrating an example of the operation of the learning device 10 according to the present embodiment, and is a diagram for describing a learning method by the learning device 10 according to the present embodiment.

The data set division unit 11 processes a new training data set on the basis of the attribute information of the new training data set. Specifically, the data set division unit 11 divides the new training data set into a plurality of divided data sets on the basis of the attribute information (step S11).

The divided data set learning unit 12 creates a new model by additionally learning new training data processed by the data set division unit 11 for the existing model.

Specifically, the divided data set learning unit 12 performs model learning processing of creating a learned model by additionally learning one divided data set among the plurality of divided data sets for a learning target model (step S12). As described above, the existing model is input to the divided data set learning unit 12 as a learning target model. Therefore, the divided data set learning unit 12 first performs the model learning processing using the existing model as a learning target model.

The divided data set learning unit 12 determines whether all the divided data sets have been learned (step S13).

In a case where it is determined that all the divided data sets have been learned (step S13: Yes), the divided data set learning unit 12 outputs a new model and ends the processing. For example, the divided data set learning unit 12 outputs a learned model created by learning of the final divided data set as a new model.

In a case where it is determined that all the divided data sets have not been learned (there is an unlearned divided data set) (step S13: No), the divided data set learning unit 12 returns to the processing of step S12 and additionally learns the unlearned divided data set for the learning target model. In this manner, after performing the model learning processing using the existing model as a learning target model, the divided data set learning unit 12 sets a learned model created by the model learning processing as a new learning target model and repeats the model learning processing until all the divided data sets are learned.

In this manner, the learning device 10 according to the present embodiment includes the data set division unit 11 as a training data processing unit and the divided data set learning unit 12 as a model learning unit. The data set division unit 11 processes a new training data set on the basis of attribute information of an existing training data set or the new training data set. Specifically, the data set division unit 11 divides the new training data set into a plurality of divided data sets on the basis of the attribute information. The divided data set learning unit 12 creates a new model by additionally learning processed new training data sets for an existing model.

Specifically, after performing model learning processing using the existing model as a learning target model, the divided data set learning unit 12 repeats the model learning processing until all the data sets are learned using a learned model created by the model learning processing as a new learning target model.

Furthermore, the learning method according to the present embodiment includes a step of processing a new training data set and a step of learning a new model. In the step of processing a new training data set, the new training data set is processed on the basis of attribute information of an existing training data set or the new training data set. Specifically, in the step of processing a new training data set, the new training data set is divided into a plurality of divided data sets on the basis of the attribute information (step S11). In the step of learning a new model, a new model is created by processed new training data sets being additionally learned for an existing model. Specifically, in the step of learning a new model, after model learning processing is performed using the existing model as a learning target model, a new model is created by the model learning processing being repeated until all the divided data sets are learned using a learned model created by the model learning processing as a new learning target model (steps S12 to S13).

By a new model being created by a new training data set being processed on the basis of attribute information, and processed new training data sets being additionally learned for an existing model, additional learning can be performed in consideration of the attribute of data included in the training data set, and thus degradation of estimation accuracy can be suppressed in a case where the new training data is additionally learned for the existing model.

Specifically, by learning of a learned data set obtained by dividing on the basis of attribute information being repeated, forgetting of a learned tendency of an existing training data set can be suppressed as compared with a case where a large amount of new training data is learned at a time. Therefore, deterioration of estimation accuracy for the existing training data set can be suppressed. Furthermore, by a new training data set being divided according to attribute information, a parameter of a model for each attribute can be gently updated in multiple stages, and thus deterioration of estimation accuracy for the existing training data set can be suppressed.

### Second Embodiment

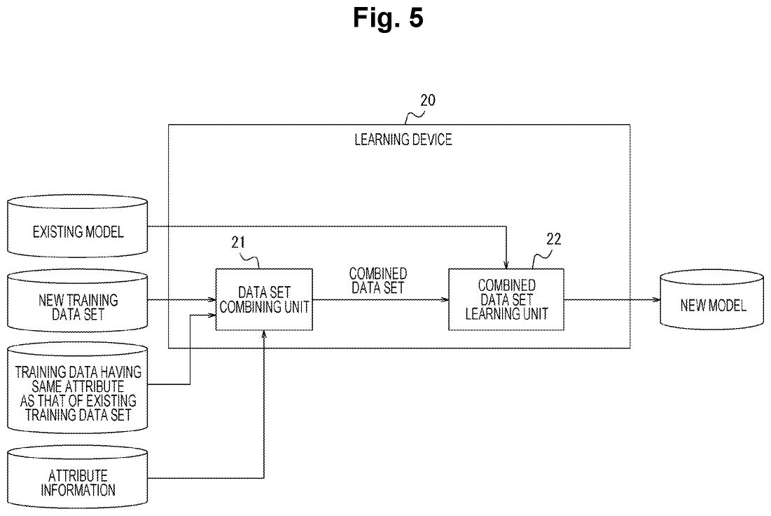

FIG. 5 is a diagram illustrating a functional configuration example of a learning device 20 according to a second embodiment of the present disclosure.

As illustrated in FIG. 5, the learning device 20 according to the present embodiment includes a data set combining unit 21 and a combined data set learning unit 22.

A new training data set, attribute information, and a training data set having the same attribute as that of an existing training data set are input to the data set combining unit 21. The training data having the same attribute as that of the existing training data set is training data having the same attribute as the attribute of the existing training data discriminated from information of data of the existing training data set included in attribute information of a data set. For example, the training data having the same attribute as that of the existing training data set is training data having classification such as an industry to be handled in the contact center, service to be inquired, and a purpose of the inquiry similar to that of the existing training data set. A training data set having the same attribute as that of the existing training data set may be created by being selected from the existing training data set or may be newly prepared.

The data set combining unit 21 as a training data processing unit processes the new training data set on the basis of attribute information of the existing training data set or the new training data set. Specifically, the data set combining unit 21 combines the new training data set and the training data having the same attribute as that of the existing training data set, and outputs the data set to the combined data set learning unit 22 as the combined data set. That is, the data set combining unit 21 adds the training data having the same attribute as that of the existing training data set to the new training data set. The ratio of combining the new training data set and the training data having the same attribute as that of the existing training data set may be any ratio.

The combined data set learning unit 22 receives an existing model and the combined data set output from the data set combining unit 21. The combined data set learning unit 22 additionally learns the combined data set for the existing model and outputs the combined data set as a new model. That is, the combined data set learning unit 22 creates a new model by additionally learning new training data to which the training data having the same attribute as that of the existing training data set is added for the existing model.

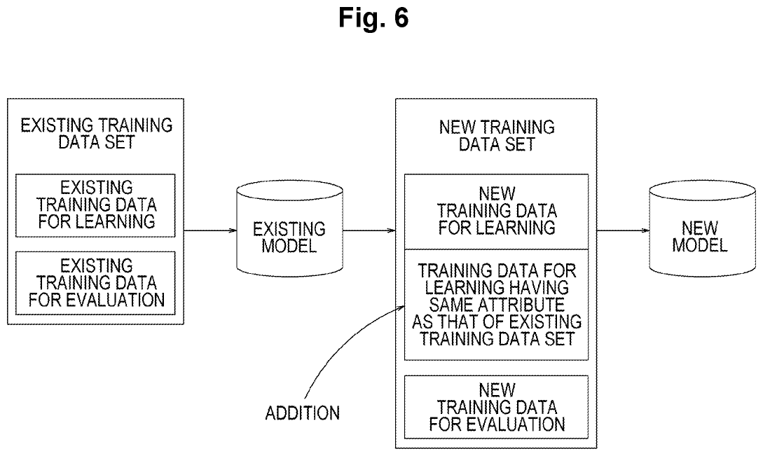

FIG. 6 is a diagram schematically illustrating learning of a new model by the learning device 20 according to the present embodiment.

As illustrated in FIG. 6, an existing model is created by learning an existing training data set including existing training data for learning and existing training data for evaluation. In a case where a new model is created by a new training data set including the existing training data for learning and the existing training data for evaluation being additionally learned for the existing model created by learning of the existing training data set, the data set combining unit 21 adds training data having the same attribute as that of the existing training data set to the new training data set. Specifically, the data set combining unit 21 adds training data for learning having the same attribute as that of the existing training data set to a new training data set for learning. The data set combining unit 21 may add the training data to the new training data set such that the combination ratio between the new training data set and the training data having the same attribute as that of the existing training data set is a constant ratio for each attribute. The data set combining unit 21 may add training data for evaluation having the same attribute as that of the existing training data set to a new training data set for evaluation. In this case, for example, the data set combining unit 21 equalizes the ratio between the new training data for learning and the training data for learning having the same attribute as that of the existing training data set to the ratio between the new training data for evaluation and the training data for evaluation having the same attribute as that of the existing training data set.

By a training data set in which training data having the same attribute as that of an existing training data set is added to a new training data set being additionally learned, the new training data set can be additionally learned while deterioration of estimation accuracy for the existing training data is suppressed. As a result, deterioration of estimation accuracy can be suppressed in a case where new training data is additionally learned for an existing model.

Next, operation of the learning device 20 according to the present embodiment will be described.

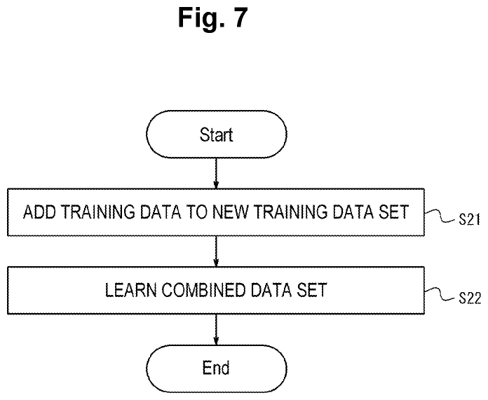

FIG. 7 is a flowchart illustrating an example of the operation of the learning device 20 according to the present embodiment, and is a diagram for describing a learning method by the learning device 20 according to the present embodiment.

The data set combining unit 21 adds training data having the same attribute as that of an existing training data set to a new training data set (step S21), and outputs the data set to the combined data set learning unit 22 as a combined data set.

The combined data set learning unit 22 additionally learns the combined data set output from the data set combining unit 21 for an existing model (step S22), and creates a new model.

In this manner, the learning device 20 according to the present embodiment includes the data set combining unit 21 as a training data processing unit and the combined data set learning unit 22 as a model learning unit. The data set combining unit 21 processes a new training data set on the basis of attribute information of an existing training data set or the new training data set. Specifically, the data set combining unit 21 adds training data having the same attribute as that of the existing training data set to the new training data set. The combined data set learning unit 22 creates a new model by additionally learning the processed new training data sets for the existing model. Specifically, the combined data set learning unit 22 creates a new model by additionally learning the new training data to which the training data having the same attribute as that of the existing training data set is added for the existing model.

Furthermore, the learning method according to the present embodiment includes a step of processing a new training data set and a step of learning a new model. In the step of processing a new training data set, the new training data set is processed on the basis of attribute information of an existing training data set or the new training data set. Specifically, in the step of processing a new training data set, training data having the same attribute as that of the existing training data set is added to the new training data set (step S21). In the step of learning a new model, a new model is created by processed new training data sets being additionally learned for an existing model. Specifically, in the step of learning a new model, a new model is created by the new training data to which the training data having the same attribute as that of the existing training data set is added being additionally learned for the existing model.

By a new training data set to which training data having the same attribute as that of an existing training data set is added being additionally learned, deterioration of estimation accuracy for a data set that has been learned in the past is suppressed. Therefore, deterioration of estimation accuracy for the existing training data set can be suppressed.

### Third Embodiment

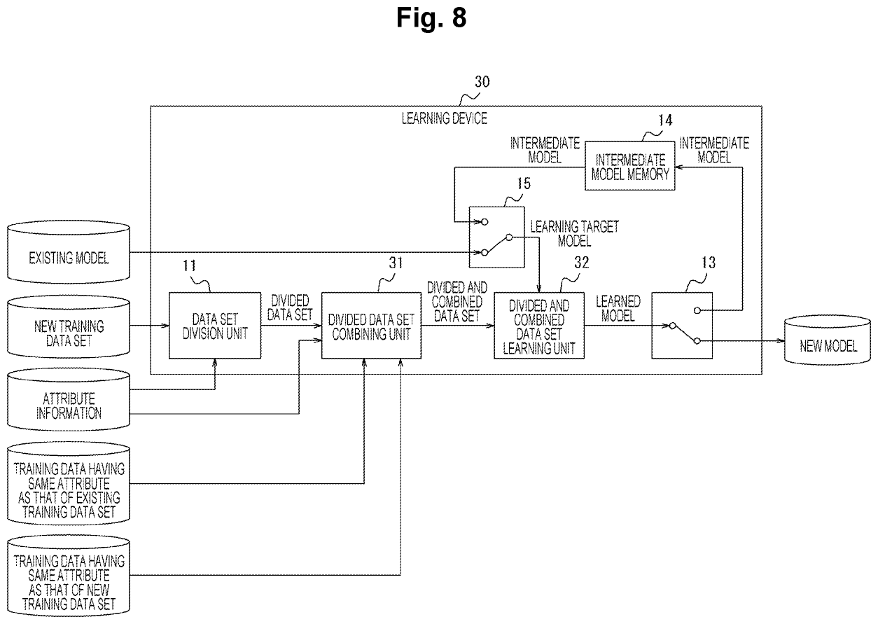

FIG. 8 is a diagram illustrating a configuration example of a learning device 30 according to a third embodiment of the present disclosure. In FIG. 8, configurations similar to those in FIG. 2 are denoted by the same reference signs, and description thereof will be omitted.

As illustrated in FIG. 8, the learning device 30 according to the present embodiment includes a data set division unit 11, a divided data set combining unit 31, a divided and combined data set learning unit 32, switching units 13 and 15, and an intermediate model memory 16. The learning device 30 according to the present embodiment is different from the learning device 10 according to the first embodiment in that the divided data set combining unit 31 and the divided and combined data set learning unit 32 are added. The data set division unit 11 and the divided data set combining unit 31 form a training data processing unit.

The divided data set combining unit 31 receives divided data sets output from the data set division unit 11, attribute information, training data having the same attribute as that of an existing training data set, and training data having the same attribute as that of a new training data set. The divided data set combining unit 31 adds the training data having the same attribute as that of the existing training data set to the divided data sets. Furthermore, the divided data set combining unit 31 adds, to a divided data set, training data having the same attribute as that of a divided data set learned before the divided data set (divided new training data set), and outputs the divided training data set to the divided and combined data set learning unit 32 as a divided and combined data set. The ratio of combining the new training data set, the training data having the same attribute as that of the existing training data set, and the training data having the same attribute as that of the new training data set learned before the new training data set may be any ratio.

As described above, in the present embodiment, the training data processing unit including the data set division unit 11 and the divided data set combining unit 31 divides the new training data set into a plurality of divided data sets on the basis of the attribute information, and adds the training data having the same attribute as that of the existing training data set to each of the plurality of divided data sets. Furthermore, in the present embodiment, the training data processing unit including the data set division unit 11 and the divided data set combining unit 31 adds, to a divided data set, training data having the same attribute as that of a divided data set learned before the divided data set.

The divided and combined data set learning unit 32 receives the divided and combined data set output from the divided data set combining unit 31 and a learning target model output from the switching unit 15. The divided and combined data set learning unit 32 as a model learning unit creates a new model by additionally learning a processed new training data set (divided and combined data set) for the learning target model. Specifically, the divided and combined data set learning unit 32 performs model learning processing of creating a learned model by additionally learning one divided data set among the plurality of divided data sets for the input learning target model, and outputs the model after the learning to the switching unit 13 as a learned model. As described above, an existing model is first output as a learning target model from the switching unit 15, and thereafter an intermediate model is output as a learning target model. Therefore, after performing the model learning processing using the existing model output from the switching unit 15 as a learning target model, the divided and combined data set learning unit 32 repeats the model learning processing until all the divided and combined data sets are learned using a learned model created by the model learning processing as a new learning target model.

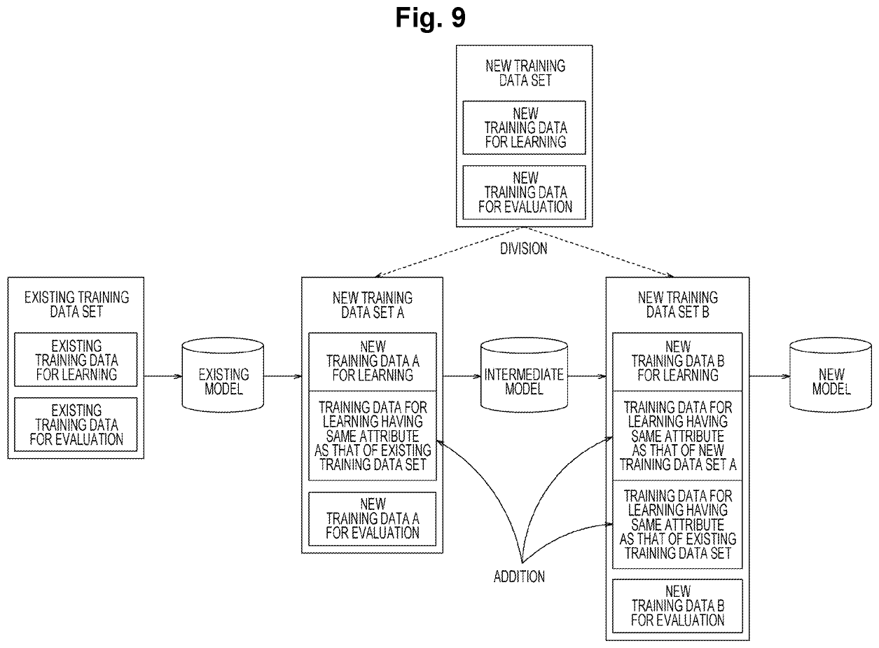

FIG. 9 is a diagram schematically illustrating learning of a new model by the learning device 30 according to the present embodiment.

As illustrated in FIG. 9, an existing model is created by learning an existing training data set including existing training data for learning and existing training data for evaluation. In a case where a new model is created by a new training data set including the existing training data for learning and the existing training data for evaluation being additionally learned for the existing model created by learning of the existing training data set, the data set division unit 11 divides the new training data set into a plurality of data sets (new training data set A and new training data set B in FIG. 9) as in the first embodiment.

The divided data set combining unit 31 adds training data for learning having the same attribute as that of the existing training data set to the new training data set A and the new training data set B. The divided and combined data set learning unit 32 creates an intermediate model by additionally learning the new training data set A for the existing model.

Since the new training data set A has been additionally learned, the divided data set combining unit 31 adds training data for learning having the same attribute as that of the new training data set A to the new training data set B. The divided and combined data set learning unit 32 creates a new model by additionally learning the new training data set B for the intermediate model created by learning of the training data set A.

Note that, in FIG. 9, an example in which a new training data set is divided into two and training data having the same attribute as that of a new training data set learned one step before is added to a new training data set B has been described, but the present disclosure is not limited thereto. The divided data set combining unit 31 may add, to a divided data set, training data having the same attribute as that of a divided data set learned in any number of steps before the divided data set. The divided data set combining unit 31 may add training data for evaluation having the same attribute as that of an existing training data set to a new training data set A and a new training data set B, or may add training data for evaluation having the same attribute as that of the new training data set A to the new training data set B.

Next, operation of the learning device 30 according to the present embodiment will be described.

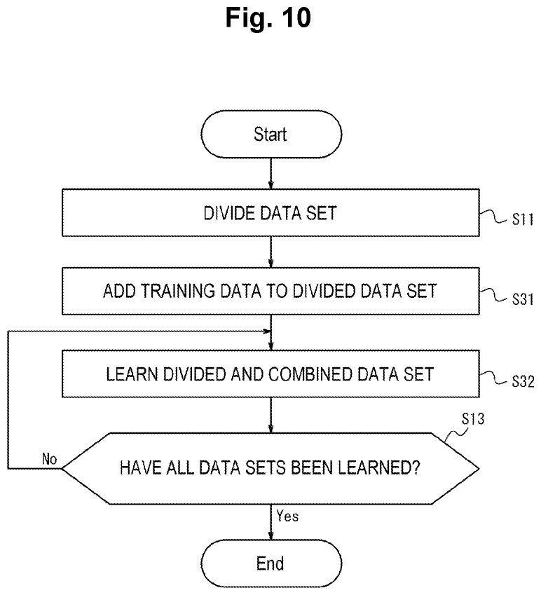

FIG. 10 is a flowchart illustrating an example of the operation of the learning device 30 according to the present embodiment, and is a diagram for describing a learning method by the learning device 30 according to the present embodiment.

The divided data set combining unit 31 adds training data having the same attribute as that of an existing training data set to each of a plurality of divided data sets obtained by dividing a new training data set by the data set division unit 11. Furthermore, the divided data set combining unit 31 adds, to a divided data set, training data having the same attribute as that of a divided data set learned before the divided data set according to the order in which the plurality of divided data sets are learned (step S31), and outputs the divided training data set to the divided and combined data set learning unit 32 as a divided and combined data set.

The divided and combined data set learning unit 32 performs model learning processing of creating a learned model by additionally learning one divided data set among the plurality of divided data sets for a learning target model (step S32). As described above, the existing model is first input as a learning target model, and thereafter an intermediate model is input as a learning target model to the divided and combined data set learning unit 32.

After the processing of step S32, the divided and combined data set learning unit 32 determines whether all the divided and combined data sets have been learned (step S13). In this way, the divided and combined data set learning unit 32 learns one divided and combined data set for the existing model, and then repeats the model learning processing until all the divided and combined data sets are learned using intermediate models as learning target models.

In this manner, the learning device 30 according to the present embodiment includes the data set division unit 11 and the divided data set combining unit 31 as a training data processing unit and the divided and combined data set learning unit 32 as a model learning unit. The data set division unit 11 and the divided data set combining unit 31 divides a new training data into a plurality of divided data sets on the basis of attribute information, and adds training data having the same attribute as that of training data of an existing training data set to each of the plurality of divided data sets. Furthermore, the divided data set combining unit 31 adds, to a divided data set, training data having the same attribute as that of a divided data set learned before the divided data set. After performing model learning processing using the existing model as a learning target model, the divided and combined data set learning unit 32 repeats the model learning processing until all the data sets are learned using a learned model created by the model learning processing as a new learning target model.

Furthermore, the learning method according to the present embodiment includes a step of processing a new training data set and a step of learning a new model. In the step of processing a new training data set, a new training data set is divided into a plurality of divided data sets on the basis of attribute information, and training data having the same attribute as that of training data of an existing training data set is added to each of the plurality of divided data sets. Furthermore, in the step of processing a new training data set, training data having the same attribute as that of a divided data set learned before a divided data set is added to the divided data set. In the step of learning a new model, after model learning processing is performed using an existing model as a learning target model, the model learning processing is repeated until all the data sets are learned using a learned model created by the model learning processing as a new learning target model.

By a new training data set being processed on the basis of attribute information, and a new model being created by a processed new training data set being additionally learned for an existing model, additional learning can be performed in consideration of the attribute of data included in a training data set, and thus degradation of estimation accuracy can be suppressed in a case where the new training data is additionally learned.

As described above, in the present embodiment, similarly to the first embodiment, by learning of a learned data set obtained by dividing new training data into a plurality of divided data sets being repeated, forgetting of a tendency learned for an existing training data set can be suppressed and deterioration of estimation accuracy for the existing training data set can suppressed.

Furthermore, in the present embodiment, similarly to the second embodiment, by training data having the same attribute as that of the existing training data and training data having the same attribute as that of a divided data set learned before a divided data set being added to the divided data set, deterioration of estimation accuracy for a data set learned in the past can be suppressed. Therefore, deterioration of estimation accuracy for the existing training data set can be suppressed.

### Fourth Embodiment

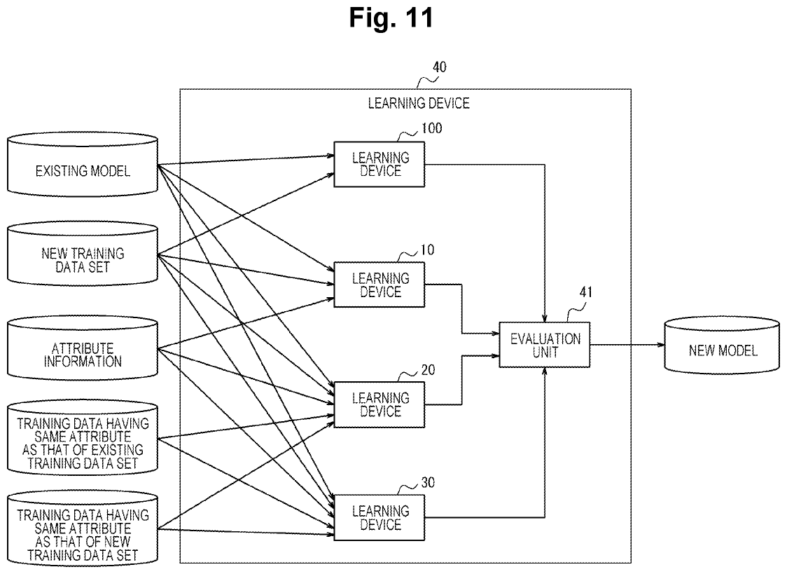

FIG. 11 is a diagram illustrating a functional configuration example of a learning device 40 according to a fourth embodiment of the present disclosure.

As illustrated in FIG. 11, the learning device 40 according to the present embodiment includes a learning device 100, the learning device 10 according to the first embodiment, the learning device 20 according to the second embodiment, the learning device 30 according to the third embodiment, and an evaluation unit 41.

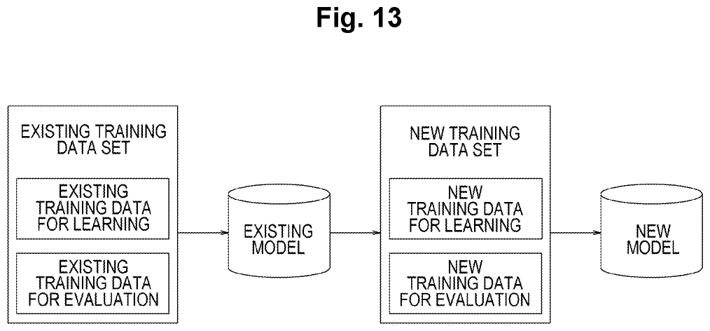

As illustrated in FIG. 13, the learning device 100 creates a new model by additionally learns a new training data set collectively for an existing model created by learning of an existing training data set.

The evaluation unit 41 evaluates a model created by the learning device 100 (first model), a model created by the learning device 10 (second model), a model created by the learning device 20 (third model), and a model created by the learning device 30 (fourth model), and determines one of first to fourth models as a new model according to the evaluation results. The evaluation unit 41 determines a model having the best index such as precision, recall, or an f1-score among the first to fourth models as a new model.

A model having higher estimation accuracy can be obtained by a model having the best evaluation result being determined as a new model according to the use of the model from the models created by each of the learning devices 10, 20, 30, and 100.

The inventors of the present application evaluated the estimation accuracy by the new models created by each of the learning devices 10, 20, 30, and 100 described above. Hereinafter, a method of creating a new model by the learning device 10 will be referred to as a first method, a method of creating a new model by the learning device 20 will be referred to as a second method, a method of creating a new model by the learning device 30 will be referred to as a third method, and a method of creating a new model by the learning device 100 will be referred to as a fourth method.

First, a method of creating a model will be described. As an existing model, training data for 180 calls was learned as an existing training data set, and an existing model was created.

In the first method, a training data set for 373 calls that is a new training data set was divided into a first training data set for 188 calls and a second training data set for 185 calls. Then, an intermediate model was created by the first training data set being additionally learned for the existing model described above.

Furthermore, a new model was created by the second training data set being additionally learned as a new training data set for the intermediate model.

In the second method, a training data set for 82 calls having the same attribute as that of the existing training data set was added to the training data set for 373 calls that is a new training data set. Then, a new model was created by new training data to which the existing training data has been added being additionally learned for the existing model.

In the third method, the training data set for 373 calls that is a new training data set was divided into the first training data set for 188 calls and the second training data set for 185 calls. Furthermore, training data for 58 calls having the same attribute as that of the existing training data set was added to the first training data set. Furthermore, training data for 57 calls having the same attribute as that of the existing training data set and a training data set for 78 calls having the same attribute as that of the first training data set were added to the second training data set. Then, an intermediate model was created by the first training data to which the training data has been added being additionally learned for the existing model. Furthermore, a new model was created by the second training data to which the training data has been added being additionally learned for the intermediate model.

In the fourth method, a new model was created by the training data set for 373 calls that is a new training data set being additionally learned collectively for the existing model.

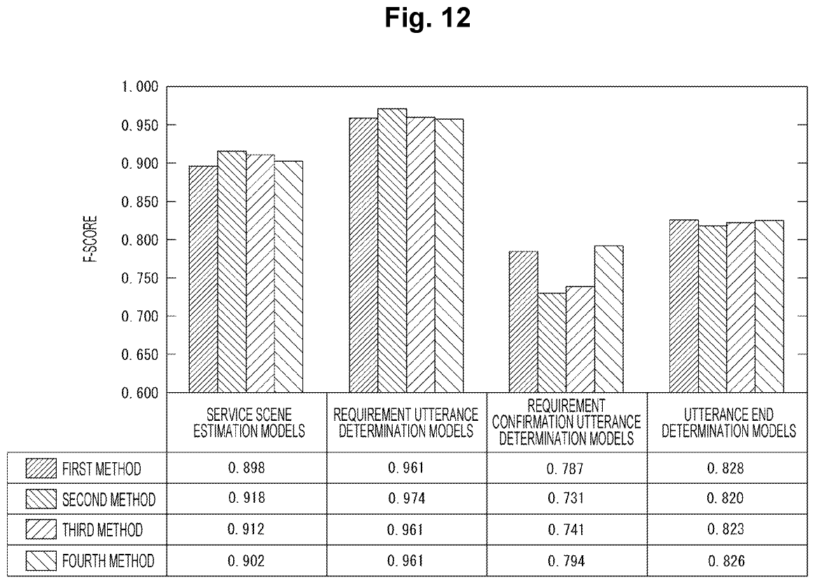

According to first to fourth methods described above, service scene estimation models for estimating scene labels, requirement utterance determination models/requirement confirmation utterance determination models for estimating requirement labels/requirement confirmation labels, and utterance end determination models for estimating utterance end labels were generated, and the accuracy of the generated models was evaluated by f1-scores. The evaluation results are illustrated in FIG. 12.

As illustrated in FIG. 12, in the service scene estimation models, the highest estimation accuracy was obtained particularly in the model created by the second method. In the requirement utterance determination models, the highest determination accuracy was obtained particularly in the model created by the second method. In the requirement confirmation utterance determination models, the highest determination accuracy was obtained particularly in the model created by the fourth method, and determination accuracy close to that was obtained in the model created by the first method. In the utterance end determination models, substantially equivalent determination accuracy was obtained by the first method to the fourth method.

As described above, it has been found that the method for obtaining good estimation accuracy varies depending on the labels to be estimated. Therefore, the evaluation unit 41 may determine any one of the first to fourth models as a new model according to the labels to be estimated on the basis of the evaluation results obtained in advance or the like. For example, the evaluation unit 41 may determine the model created by the learning device 20 as a new model for a service scene estimation model. Furthermore, the evaluation unit 41 may determine the model created by the learning device 20 as a new model for a requirement utterance determination model, and may determine the model created by the learning device 10 or the learning device 40 as a new model for a requirement confirmation utterance determination model.

With regard to the above embodiments, the following supplementary notes are further disclosed.

(Supplement 1)

A learning device including
a memory, and
at least one processor connected to the memory,
in which the processor
processes a new training data set on the basis of attribute information of an existing training data set or the new training data set, and
creates the new model by additionally learning the processed new training data set for an existing model learned using the existing training data.

(Supplement 2)

A non-transitory storage medium that stores a program that can be executed by a computer, the non-transitory storage medium causing the computer to function as the learning device according to the supplement 1.

All documents, patent applications, and technical standards described in this specification are incorporated herein by reference to the same extent as if each individual document, patent application, and technical standard were specifically and individually described to be incorporated by reference.

### REFERENCE SIGNS LIST

10, 20, 30, 40, 100 Learning device
11 Data set division unit (training data processing unit)
12 Divided data set learning unit (model learning unit)
13, 15 Switching Unit
14 Intermediate model memory
21 Data set combining unit (training data processing unit)
22 Combined data set learning unit (model learning unit)
31 Divided data set combining unit (training data processing unit)
32 Divided and combined data set learning unit (model learning unit)
41 Evaluation unit
110 Processor
120 ROM
130 RAM
140 Storage
150 Input unit
160 Display unit
170 Communication interface
190 Bus

1. A learning device comprising a processor configured to execute operations comprising:
generating a new training data set on a basis of attribute information of an existing training data set; and
creating a new model by additionally learning the new training data set for an existing model.

2. The learning device according to claim 1,
wherein the generating the new training data set further comprises dividing the new training data set into a plurality of divided data sets on a basis of the attribute information of the existing training data set, and
the creating the new model further comprises additionally learning one divided data set among the plurality of divided data sets for a learning target model using the existing model as the learning target model, and repeating the learning of the learning target model until all divided data sets of the plurality of divided data sets are learned.

3. The learning device according to claim 1,
wherein the generating the new training data set further comprises adding training data having a same attribute as that of the existing training data set to the new training data set, and
the creating the new model further comprises creating the new model by additionally learning new training data to which training data having a same attribute as that of the existing training data set is added for the existing model.

4. The learning device according to claim 2,
wherein generating the new training data set further comprises adding training data having a same attribute as that of the existing training data set to each of the plurality of divided data sets,
the creating the new model further comprises additionally learning one divided data set among the plurality of divided data sets to which the training data has been added for the learning target model using the existing model as the learning target model, and repeating the learning of the learning target model until all the divided data sets are learned, and
the generating the new training data further comprises adding training data having a same attribute as that of a divided data set learned before the divided data set to the corresponding divided data set.

5. A learning device comprising a processor configured to execute operations comprising:
evaluating:
a first model created by collectively performing additional learning of a new training data set for an existing model according to attribution information of an existing training data set,
a second model created by:
dividing the new training data set into a plurality of divided data sets based on the attribute information of an existing training data set,
additionally learning one divided data set among the plurality of divided data sets for a learning target model, and
repeating the learning of the learning target model until all divided data sets of the plurality of divided data sets are learned,
a third model created by:
adding the training data having a same attribute as that of the existing training data set to each of the plurality of divided data sets, and
additionally learning the new training data to which the training data having the same attribute as that of the existing training data set is added for the existing model,
a fourth model created by:
adding the training data having the same attribute as that of the existing training data set to each of the plurality of divided data sets,
additionally learning the one divided data set among the plurality of divided data sets to which the training data has been added for the learning target model using the existing model as the learning target model, and
repeating the learning of the learning target model until all the divided data sets are learned; and
determining, based on at least one of the first model, the second model, the third model, or the fourth model, a new model according to a result from the evaluating.

6. A method for learning a new model, the method comprising:
generating a training data set on a basis of attribute information of an existing training data set; and
creating the new model by additionally learning the new training data set for an existing model.

7. (canceled)

8. The method according to claim 6,
wherein the generating the new training data set further comprises dividing the new training data set into a plurality of divided data sets on a basis of the attribute information, and
the creating the new model further comprises additionally learning one divided data set among the plurality of divided data sets for a learning target model using the existing model as the learning target model, and repeating the learning of the learning target model until all divided data sets of the plurality of divided data sets are learned.

9. The method according to claim 6,
wherein the generating the new training data set further comprises adding training data having a same attribute as that of the existing training data set to the new training data set, and
the creating the new model further comprises creating the new model by additionally learning new training data to which training data having a same attribute as that of the existing training data set is added for the existing model.

10. The method according to claim 9,
wherein generating the new training data set further comprises adding the training data having a same attribute as that of the existing training data set to each of the plurality of divided data sets,
the creating the new model further comprises additionally learning one divided data set among the plurality of divided data sets to which the training data has been added for a learning target model using the existing model as the learning target model, and repeating the learning of the learning target model until all divided data sets of the plurality of divided data sets are learned, and
the generating the new training data further comprises adding training data having a same attribute as that of a divided data set learned before the divided data set to the corresponding divided data set.
